(19) United States
(12) Patent Application Publication
(10) Pub. No.: US 2016/0198543 A1
(43) Pub. Date: Jul. 7, 2016

(54) LUMINOUS SOURCE WITH PLEASING LIGHT

(71) Applicant: MARTINI SPA, Concordia Sulla Secchia (IT)

(72) Inventors: Giorgio Martini, Concordia Sulla Secchia (IT); Giulio Vezzani, San Martino In Rio (IT)

(73) Assignee: MARTINI SPA, Concordia Sulla Secchia (IT)

(21) Appl. No.: 14/911,008

(22) PCT Filed: Aug. 8, 2014
(86) PCT No.: PCT/IB2014/063807

§ 371 Date: Feb. 8, 2016

(30) Foreign Application Priority Data
Aug. 8, 2013 (IT) UD2013A000104

(51) Int. Cl. H05B 33/08

(52) U.S. Cl. CPC H05B 33/0857

(57) ABSTRACT

Luminous source with pleasing light having a light emission spectrum with color temperatures comprised between 2500K and 6500K and provided with three peaks of light emission (R, G, B) situated in correspondence to the red, green and blue colors.

### FIELD OF THE INVENTION

The present invention concerns a luminous source that emits a pleasing light, that is, a light which is perceived as a natural light, neither too warm nor too cold, in practice improving the current standards used in internal or external lighting such as, merely by way of example, luminous sources of the incandescent, fluorescent and halogen type.

In particular the invention concerns the white light emitted by a luminous source of the Light Emitting Diode type, hereafter called LED, in its different configurations, that is, SingleChip, Multichip, OLED, Chip on Board (COB), remote phosphors, similar or comparable LED sources. For simplification, hereafter, reference will be made to the luminous sources of the LED type, although the inventive idea can be transferred directly to luminous sources of the SingleChip type, Multichip, OLED, remote phosphors, or similar or comparable LED sources.

### BACKGROUND OF THE INVENTION

LED Arrays are known, which currently have the least bulk in the field of LED luminous sources but an average flexibility in the definition of the light emitted.

It is indeed known that a LED converts electric energy into monochromatic light for example, blue, red, green light or other visible light, but it is not able to emit white light individually.

It is also known that LEDs comprise a light emitter material, attached to the upper surface of a printed circuit, which when electrically excited emits light.

It is also known to process the light emitter material with layers of various materials, for example phosphorus dust, rare earths, etc. in order to modify in a desired way the color of the light beam emitted by the LED and adapt it to specific application requirements.

LEDs are also known for the emission of white light that have a light emission spectrum provided with peaks of emission located in proximity to the wave lengths of 450 nm, 535 nm and 630 nm, respectively corresponding to the blue, green and red coloration. A light emission having these peaks allows the human eye to see the various colors with a greater sensitivity and with good balance.

Luminous sources with emission spectrums with three peaks are described for example, in the documents US-A-2009/0154195, US-A-2009/0261710, US-A-2007/0170842, US-A-2009/002604, US-A-2012/104957, EP-A-2.211.083, EP-A-2.164.301 and US-A-2007/0284994.

Document US-A-2009/0154195 concerns LED luminous sources for liquid crystal panels and describes light emission spectrums with a very accentuated peak in correspondence to the color red and with very limited spectral amplitudes of the other peaks too, that is, less than 50 nm. This configuration of the spectrum, although it is effective for the particular application to liquid crystal panels, does not allow a direct application to other types of application too, such as for example lighting rooms.

In document US-A-2009/0261710 the light emission spectrums proposed have ample spectral amplitudes with a consequent high saturation of the colors perceived and not a natural perception thereof.

In document US-A-2007/0170842 a luminous source is described consisting of a LED with a blue base on which layers of phosphors are laid, suitable to modify the light emission spectrum in order to generate three peaks of light emission. The formulations of light emission spectrums set forth in this document cause a high distortion of the perception of colors and therefore a light which is not pleasing to the eye. Moreover, the combination of intensities of the peaks proposed in this document causes luminous sources to be produced with a low light efficiency.

In document US-A-2009/002604 a light emission apparatus is described which includes a light emitter section provided with a plurality of luminous sources. The luminous sources each include a semi-conductor light emission element and one or more types of phosphors combined and associated to each light emission element. These luminous sources allow to obtain a light emission spectrum that shows a narrow spectral amplitude for the blue and wide spectral amplitudes for the red and green. With the solution described in this document one can appreciate how the light emission spectrum, for the different color temperatures varying between 2500K and 8000K, if it has an accentuated peak in correspondence to the green, it has a very flat zone corresponding to the red wavelength, whereas if it has an accentuated peak in correspondence to the red, it has a very flat zone in correspondence to the green.

This condition does not allow to obtain a good reproduction of the colors in correspondence to the green and/or red colors.

Document US-A-2012/104957 describes a light emission device for the emission of light by means of a blue-colored LED light emission element and by means of phosphorescent layers of red and green that are located above the blue LED light emission element. With the solution described in this document it is possible to obtain light emission spectrums with three peaks located in correspondence to the blue, green and red, where the peak in correspondence to the blue is very accentuated while the peaks in correspondence to the green and the red are not very accentuated and confer a substantially flat development on the spectrum in the variable wave lengths between green and red. This solution does not allow to achieve a good reproduction of at least the red and green colors.

Document EP-A-2.211.083 describes a solution of a light system that comprises blue, red and green phosphors used to generate a light emission spectrum with a Δuv deviation with respect to the radiation zone of the black body that is comprised between −0.02 and +0.02. This allows to obtain an emission spectrum that tries to achieve conditions of white light emission. However, in this document there are light emission spectrums in which, similarly to what was described above for documents US-A-2009/002604 and US-A-2012/104957, at least one of either the green or the red peaks are very flat and almost non-existent. These solutions therefore do not allow a good enhancement of the green and red colors for the different color temperatures.

Document EP-A-2.164.301 instead concerns a method and a system used to determine light emission spectrums with high values of indicators of chromatic yield (Color Rendering Index: CRI). However, this document does not set forth the criteria for choosing the parameters of the spectrum able to give a good quality of light suitable to faithfully reproduce all the red, blue and green colors.

Document US-A-2007/0284994 concerns an apparatus for light emission comprising, combined with each other, a blue and a green LED light emission element and a red light emission phosphor. The light emission spectrum that is obtained has very narrow spectrum amplitudes in correspondence to the blue and green colors which entail the generation of minimum points of very low light intensity between the peak of the blue color and the peak of the green color and between the peak of the green color and the peak of the red color.

These very accentuated minimum points, due precisely to the very narrow spectrum amplitudes, define zones of very dark wave lengths of the white light in correspondence to said minimum points and therefore do not allow to obtain a good reproduction and quality of the light emitted by the device.

The adoption of light emission spectrums with the characteristics set forth in the documents indicated above can be acceptable only for determinate CCTs, not satisfying a wide application band. Indeed it should be noted that in the case of high CCTs the cold colors are distorted while with reduced CCTs the warm colors are distorted.

To this purpose, there are many indicators able to supply a reasonably objective evaluation of perception of the light emitted.

One indicator that characterizes the type of light emitted is for example the color temperature, synthetically CCT, expressed in Kelvin. There are also other indicators all intended to supply specific information on the light.

Typically a “warm” source has a CCT<3200K and a high light intensity in proximity to the wave lengths relating to red. A luminous source of this type allows a user to perceive warm colors with an optimum yield while the cold colors, for example blue, are heavily distorted.

A “cold” source has a CCT<4000K and a high light intensity in proximity to the wave lengths relating to blue, and consequently the cold colors are reproduced with a high yield while the warm colors are distorted.

Among the indicators characterizing the quality of the light of a luminous source, the main one until now has been CIE-CRI, standardized by the CIE (Commission Internationale de l'Eclairage—International Lighting Commission on Illumination), also known as CRI (Color Rendering Index). The CRI gives a score from 0 to 100 where in common acceptance CRI>90 identifies a luminous source of very high reliability. However, in recent years a series of shortcomings has come to light regarding the capacity of CRI to express a correct evaluation of the quality of the light. These shortcomings concern LED sources in particular.

Currently there are new norms proposed to measure the quality of light in a more precise way, also regarding luminous sources of the LED type.

Another index is the CQS (Color Quality Index), that is, metrics proposed by the NIST (National Institute of Standards and Technology) as a possible substitute for the CRI indicator. The CQS is a quantitative measure of the ability of a luminous source to reproduce the saturated colors of the illuminated objects. This metrics provides among other things to use two indicators, that is, the Qa corresponding to the quality of the light to reproduce the color and in common acceptance identified as CQS, and the Qg or Relative Gamut area of the luminous source that gives an indication of how saturated the light emitted by the luminous source is.

The indicator MCRI (Memory Color Rendering Index) is also known, which allows to measure the perceived quality of a luminous source in reproducing the colors of illuminated objects on the basis of memory that one has of the color itself. Unlike CQS and CRI that are objective metrics, this metrics is subjective.

The indicator GAI (Gamut Area Index) measures the correlation in terms of Gamut between an illuminating source and a series of standard illuminants, among which the standard E illuminant (CCT=5545K), and gives an indication on the clarity of a color. The Gamut, as intended here, is the combination of the colors, indicated in colorimetric coordinates, that the luminous source is able to produce, and is a subset of visible colors.

The indicator LER (Luminaire Efficacy Rating) is an indicator of the light efficiency of an illumination apparatus.

In Table 1 a comparison between the above indicators is shown, identified for a plurality of luminous sources.

TABLE 1

| | | | | Qa | Qg | | | |
|---|---|---|---|---|---|---|---|---|
| | | CCT | | (CQS | (CQS | MCRI | | |
| Type | Source | (K) | CRI | 9.0) | 9.0) | (3001x) | GAI | LER |
| Theo- | A | 2864 | 100 | 100 | 100 | 83 | 53 | 247 |
| retical | CIE F12 | 3000 | 83 | 81 | 103 | 75 | 60 | 353 |
| illumi- | CIE F11 | 4000 | 83 | 81 | 102 | 82 | 82 | 337 |
| nants | CIE F10 | 5000 | 81 | 80 | 98 | 83 | 88 | 325 |
| | D50 | 5000 | 100 | 100 | 100 | 90 | 88 | 232 |
| | Illuminant E | 5456 | 96 | 98 | 104 | 92 | 100 | 239 |
| | D65 | 6504 | 100 | 100 | 100 | 90 | 97 | 248 |
| Tradi- | Super HPS | 2500 | 85 | 84 | 109 | 81 | 51 | 207 |
| tional | Neodimium | 2800 | 77 | 90 | 114 | 87 | 66 | 134 |
| | Incandescent | | | | | | | |
| | Incandescent | 2800 | 100 | 100 | 100 | 83 | 52 | 153 |
| | Halogen | 3000 | 100 | 99 | 100 | 83 | 54 | 158 |
| | Tri-Phospor | 3400 | 82 | 81 | 104 | 78 | 70 | 347 |
| | FL | | | | | | | |
| | Metal Halide | 4277 | 64 | 65 | 77 | 63 | 58 | 296 |
| | Fluorescent | 4290 | 63 | 63 | 81 | 65 | 65 | 341 |
| | 4K | | | | | | | |
| | Fluorescent | 6500 | 77 | 76 | 87 | 78 | 82 | 290 |
| | Daylight | | | | | | | |
| LED | Bridgelux | 3000 | 97 | 97 | 104 | 85 | 60 | 256 |
| | Decor | | | | | | | |
| | Cree | 3000 | 94 | 94 | 105 | 84 | 55 | 333 |
| | Citizen | 3000 | 98 | 98 | 102 | 86 | 62 | 267 |
| | Bridgelux | 4000 | 82 | 80 | 95 | 85 | 94 | 310 |

From the comparison it can be seen how the LED sources currently on the market set the target of reaching high scores on the CRI indicator, near to 100, or a value that nears that of an incandescent luminous source.

The target of reaching a CRI near to 100 with a current LED, SingleChip, Multichip, OLED, or remote phosphors source, on the other hand, actually determines a color perceived by the human eye which is not pleasing.

It should be noted how an incandescent bulb which, even if it reaches CRI, Qa and Qg values corresponding to the CQS metrics of 100, has a low value of the MCRI indicator that does not exceed MCRI=83. It should also be noted that the current luminous sources on the market are not able to exceed values of MCRI=86. This means a luminous source that is not able to make the color of an object perceived in a reliable and pleasing manner.

One purpose of the present invention is to obtain, using LED sources, a pleasing light close to or equal to natural light that is an improvement on the light emitted by an incandescent, fluorescent or halogen lamp.

Another purpose of the present invention is to produce a luminous source of the LED type that has an emission near to natural light and with colors which are not distorted.

Another purpose of the present invention is to obtain a pleasing light that is able to enhance both cold colors and warm colors, so as to allow a single illuminating body to satisfy a wide range of the market.

Another purpose of the present invention is to obtain a light which enhances the attractiveness and the clarity of the objects subjected to said light.

Another purpose of the present invention is to make a luminous source capable of emitting a light that enhances the attractiveness and the clarity of the objects that are subjected to that light and that allows to optimize the perception of pleasure of the white light emitted also in correspondence to the geographical area, or continental area, in which it is installed. In this way it is possible to define a white light, or continental white, that varies from region to region, which is able to enhance the strongly cultural character of the perception of colors.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, a luminous source with a pleasing light that solves the disadvantages described above has a light emission spectrum with color temperatures, in this case identified by the indicator CCT, comprised between 2500K and 6500K and is provided with three light emission peaks located in correspondence to the red, green and blue colors.

According to the invention the emission spectrums have:
the peak of the red comprised between 610 nm e 670 nm, and with a spectral amplitude (RΔλ_{0.5}) comprised between 45 nm and 120 nm;
the peak of the green (G) comprised between 500 nm and 570 nm, and with a spectral amplitude (GΔλ_{0.5}) comprised between 45 nm and 105 nm;
the peak of the blue (B) comprised between 420 nm and 480 nm, with a spectral amplitude (BΔλ_{0.5}) comprised between 10 nm and 30 nm.

According to another aspect of the present invention, the emission spectrum of the luminous source has chromatic coordinates (x, y) of the white point in the chromaticity space comprised in the area defined by the formula:

y=−6.079·10⁻¹⁰·x²+7.1496·10⁻⁶·x−0.0195+K

in which K is a constant number variable between −0.0054 and +0.0054.

This correlation, together with the peak determination parameters allows to identify a plurality of spectral curves that solve the problems identified in the state of the art, rendering the light beam pleasant to the human eye, without distorting the colors, that is, making it possible, at a determinate CCT, to maintain the correct ratio between the reproduction of warm colors and cold colors and the corresponding white point.

In accordance with another aspect of the present invention, between the peak of the red spectral zone or color, and the peak of the green color, the emission spectrum has a minimum point. It is also provided that the minimum value of light intensity chosen between that of the green peak and that of the red peak, in proportion to the value of light intensity of the minimum point comprised between the peak of the green and that of the red is always greater than or equal to 1.20.

This condition, combined with the conditions of spectral amplitude shown below, allow to define an emission spectrum with rather accentuated peaks of red and green. Respecting this minimum condition allows to increase the effect of saturation of the green tones and the red tones so that the green colors appear more vivid and the red colors appear warmer with respect to standard luminous sources evaluated at the same color temperature.

In possible solutions, said minimum point can be comprised in the interval of wave length from 561 to 609 nm.

In accordance with some forms of embodiment of the present invention the constant number K is preferably comprised between −0.0030 and +0.0030.

In accordance with a possible variant form of embodiment, the blue peak has a spectral amplitude less than 30 nm, preferably comprised between 10 nm and 27 nm. This assumption allows to obtain a good enhancement of the cold colors for a wide range of CCTs provided in the different applications required on each occasion by the present invention.

### BRIEF DESCRIPTION OF THE DRAWINGS

These and other characteristics of the present invention will become apparent from the following description of one form of embodiment, given as a non-restrictive example with reference to the attached drawings wherein:

FIG. 1 is a representation of a possible emission spectrum of a luminous source with pleasing light in accordance with the present invention;

FIG. 2a is a graph that shows the chromaticity space CIE 1931;

FIG. 2b is an enlarged portion of the graph in FIG. 2a in accordance with a first form of embodiment;

FIG. 2c is a variant embodiment of FIG. 2b;

FIG. 3 shows a table with parameters relating to emission spectrums of luminous sources in accordance with a first form of embodiment;

FIG. 4 is a graphic representation of emission spectrums of luminous sources which delimit minimum and maximum extremes of the emission spectrums according to the first form of embodiment;

FIG. 5 is a graphic representation of FIG. 2b that identifies emission spectrums relating to the first form of embodiment;

FIG. 6 shows a table with the parameters relating to emission spectrums of luminous sources according to a second form of embodiment;

FIG. 7 is a graphic representation of emission spectrums of luminous sources which delimit minimum and maximum extremes of the emission spectrums according to the second form of embodiment;

FIG. 8 is a graphic representation of FIG. 2b that identifies emission spectrums relating to the second form of embodiment;

FIG. 9 shows a table with parameters relating to emission spectrums of luminous sources according to a third form of embodiment;

FIG. 10 is a graphic representation of emission spectrums of luminous sources which delimit minimum and maximum extremes of the emission spectrums according to the third form of embodiment;

FIG. 11 is a graphic representation of FIG. 2b that identifies emission spectrums relating to the third form of embodiment.

To facilitate comprehension, the same reference numbers have been used, where possible, to identify identical common elements in the drawings. It is understood that elements and characteristics of one form of embodiment can conveniently be incorporated into other forms of embodiment without further clarifications.

### DETAILED DESCRIPTION OF FORMS OF EMBODIMENT

Hereafter some possible forms of embodiment of a luminous source with a pleasing light according to the present invention are described, comprising a LED matrix on which one or more layers of materials are applied, for example phosphors, that allow to obtain a determinate light emission spectrum.

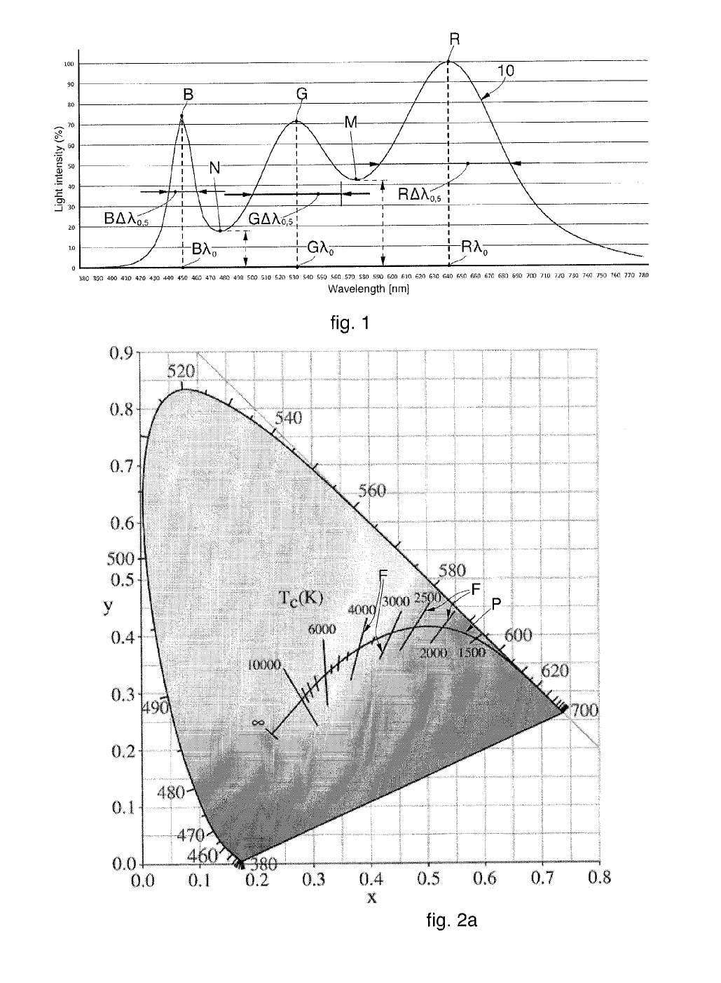

With reference to FIG. 1 a light emission spectrum according to the invention is indicated in its entirety by the reference number 10 and is defined by a curve representable in a Cartesian graph showing on the x-axis the wave length λ expressed in nanometers; the normalized light intensity I or irradiance is expressed on the y-axis, on a scale from 0 to 100 having been normalized, for each spectrum, as a function of the absolute maximum peak of each of said spectrums. The light intensity is considered normalized since it depends on the distance at which sampling is carried out. Some forms of embodiment provide that the normalization is of the percentage type on a scale from 0 to 100.

The emission spectrum 10 of FIG. 1 allows to obtain a luminous source with a color temperature CCT of 3600K.

Preferential forms of embodiment of the present invention provide that the luminous source has a color temperature CCT comprised between 2500K and 6500K.

The curve of the emission spectrum 10 is defined by the interaction of three Gaussian curves, one for each peak.

The emission spectrum 10 has three peaks, indicated respectively as B, G and R, which are disposed in correspondence to the wave lengths corresponding respectively to blue, green and red. The wave lengths for which the maximum light intensity is achieved, relating to the three peaks B, G R is indicated by λ₀. Moreover, for each bell relating to the components blue, green and red a spectral amplitude Δλ_{0.5} is identified, to which the value on the y-axis is equal to half its maximum peak value.

In said emission spectrum 10 the following parameters are also identifiable:
Bλ₀: Wave length (expressed in nm) in which the peak corresponding to the blue component is disposed, in this case at 450 nm, to which a light intensity of 74% corresponds;
Gλ₀: Wave length (expressed in nm) in which the peak corresponding to the green component is disposed, in this case at 530 nm, to which a light intensity of 71% corresponds;
Rλ₀: Wave length (expressed in nm) in which the peak corresponding to the red component is disposed, in this case at 642 nm, to which a light intensity of 100% corresponds.

For each peak of the emission spectrum 10 it is also possible to determine:
BΔλ_{0.5}: Spectral amplitude, also identifiable with the acronym “FWHM” (Full Width at Half Maximum) of the Gaussian corresponding to the color component blue to which the value on the y-axis is equal to half its maximum value, in this case 20 nm. In practice it identifies the amplitude of the Gaussian “bell”.
GΔλ_{0.5}: Spectral amplitude of the Gaussian corresponding to the color component green to which the value on the y-axis is equal to half its maximum value, in this case 65 nm.
RΔλ_{0.5}: Spectral amplitude of the Gaussian corresponding to the color component red to which the value on the y-axis is equal to half its maximum value, in this case 95 nm.

The development of the light emission spectrum 10 is therefore defined by a function of the type:

S(λ)=F_{R}(λ)+F_{G}(λ)+F_{B}(λ) (2)

F_{R}, F_{G}, F_{B} being functions of the individual components corresponding to the red, green and blue emission.

In some forms of embodiment, each of the functions F_{R}, F_{G}, F_{B} are also correlated to a multiplication factor, respectively P_{R}, P_{G}, P_{B}, that allow to define peak powers or “Peak Power Ratios” of each of the components. That is to say:

F_{R}(λ)=P_{R}·S_{R}(λ) F_{G}(λ)=P_{G}·S_{G}(λ)

F_{B}(λ)=P_{B}·S_{B}(λ)

The multiplication factors P_{R}, P_{G}, P_{B} express the proportionality between the various red, green and blue components of the spectrum equalized with respect to the peak of the green P_{G} whose value is always 1, while S_{R}, S_{G}, S_{B}, express respectively the development of the emission spectrum for each of the components red, green and blue.

Each of the S_{R}, S_{G}, S_{B} has a development near to that of a Gaussian, and can be expressed by the formula:

S_{R,G,B}(λ,λ₀,Δλ_{0.5})={g(λ,λ₀,Δλ_{0.5})+2·g⁵(λ,λ₀,Δλ_{0.5})}/3

in which g(λ,λ₀,Δλ_{0.5})=exp{−[(λ−λ₀)/λ_{0.5}]²}

Between the peak of the red color R and the peak of the green color G, the emission spectrum 10 has a first minimum point M, and between the peak of the green color G and the peak of the blue color B the spectrum has a second minimum point N. In particular, in the first M and in the second minimum point N, the emission spectrum 10 has a minimum value of light intensity with respect to values comprised between the respective two peaks.

In accordance with the form of embodiment shown in FIG. 1, the first minimum point M is located at about 570 nm and has a light intensity of about 43%.

The second minimum point N, on the other hand, is located at about 475 nm and has a light intensity of about 18%.

In accordance with forms of embodiment of the present invention, possibly combinable with the forms of embodiment described here, it is provided that the minimum value of light intensity chosen between that of the green peak and that of the red peak, in proportion to the value of light intensity of the first minimum point M comprised between the peak of the green and that of the red is always greater than or equal to 1.20.

This condition, combined with the conditions of spectral amplitude shown below, allows to define an emission spectrum 10 with particularly accentuated peaks of red and green.

Respecting this minimum condition allows to increase the effect of saturation of the green and the red tones so that the green colors appear more vivid and the red colors appear warmer with respect to standard luminous sources evaluated at the same color temperature.

In accordance with one possible solution said ratio is less than 10, and preferably less than or equal to 5. This condition avoids generating a first very accentuated minimum point, that is, with a low light intensity, with respect to the peaks of green and red, and therefore avoids generating in the emission spectrum areas of very dark wave length which do not allow to enhance the coloration of the light since it increases in too accentuated a manner the saturation emitted and consequently distorts the perceived color of the objects which are illuminated.

In accordance with the form of embodiment in FIG. 1, the minimum value of light intensity chosen from between the peak of the green and the peak of the red is the green peak with a light intensity of about 71%, while the ratio between the value of light intensity of the green peak and that of the first minimum point M is about 1.65.

Another parameter relating to the emission spectrum 10 is the chromatic distance Δuv, that is, the chromatic distance between the white point of the desired source, and the white point of a black body radiating at the same value of the CCT index.

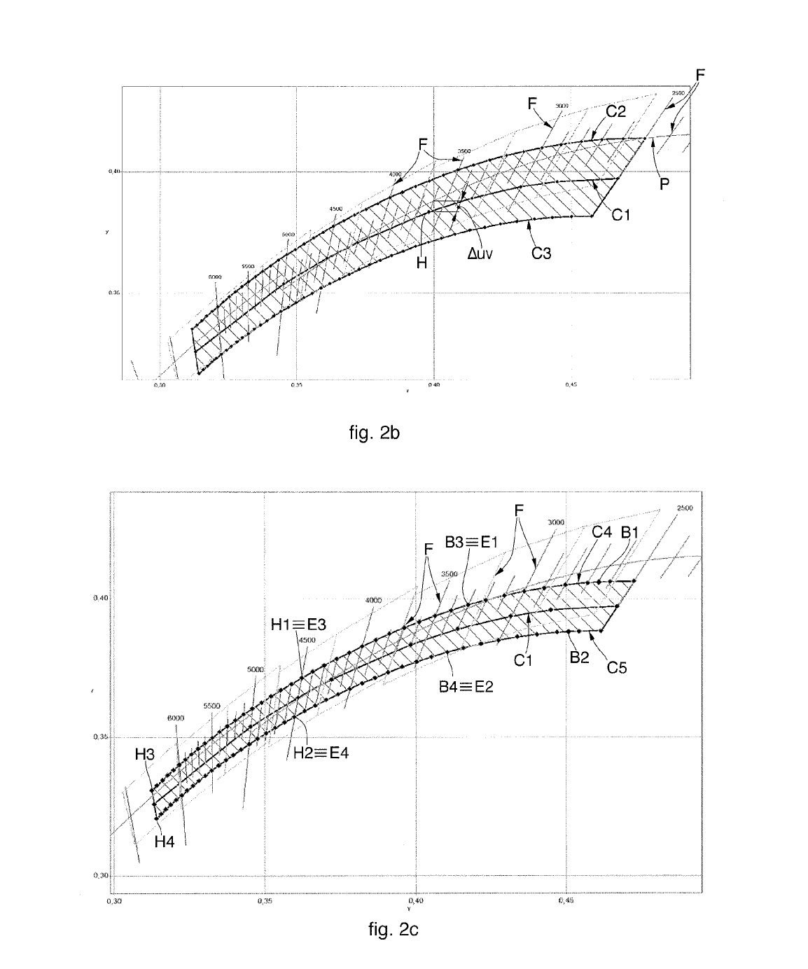

This parameter is identifiable in the chromaticity space, or Planckian space shown in FIG. 2a, that defines a luminous radiation from the chromatic point of view, through the quantification of two chromatic coordinates (x, y).

In the chromaticity space, a portion of which is shown in FIG. 2b, the curve of the chromatic coordinates characteristic of the radiation emitted by a black body at different color temperatures, called Planck curve, is also shown, and a plurality of straight lines, called isoproximal lines intersecting the Planck curve. The points of each straight line have the property of having same color temperature CCT. In FIG. 2a the Planck curve is indicated by the arrow P while the isoproximal lines are indicated by the arrows F.

The distance of the chromatic point considered, evaluated along the corresponding isoproximal line with respect to the Planck curve, corresponds to the chromatic distance Δuv. In the chromaticity space of FIG. 2b, the point H identifies the position of the emission spectrum shown in FIG. 1 and the chromatic distance Δuv is −0.00165.

In accordance with one possible solution of the present invention the chromatic distance Δuv, for different emission spectrums 10 according to the present invention, has a value comprised between −0.0108 and 0.0067.

In accordance with some forms of embodiment it is provided that the luminous sources according to the invention have a light emission spectrum, in the chromaticity space, comprised in the area defined by the formula:

y=−6.079·10⁻¹⁰·x²+7.1496·10⁻⁶·x−0.0195+K

where x and y are the chromatic coordinates in the chromaticity space and K is a constant variable number between −0.0054 and +0.0054.

Possible forms of embodiment of the present invention provide that the constant number K is comprised between −0.0030 and +0.0030.

In FIG. 2b the curve expressed by the formula shown above for K=0 is indicated by the arrow C1, the curve for K=0.0054 is indicated by the arrow C2, and the curve for K=−0.0054 is indicated by the arrow C3.

In the form of embodiment shown in FIG. 2c, the curve expressed by the formula shown above for K=+0.0030 is indicated by the arrow C4, while the curve for K=−0.0030 is indicated by the arrow C5.

The conditions identified above allow to define, in the chromaticity space, an area which includes the sources of illumination with spectral curves that allow to obtain the purposes of the invention. FIG. 2b shows, with a background of dashes, the area which includes the sources of illumination with K comprised between ±0.0054, while FIG. 2c shows the area which includes the sources of illumination with K comprised between ±0.0030.

We shall now describe examples of forms of embodiment of luminous sources according to the present invention.

### Example 1

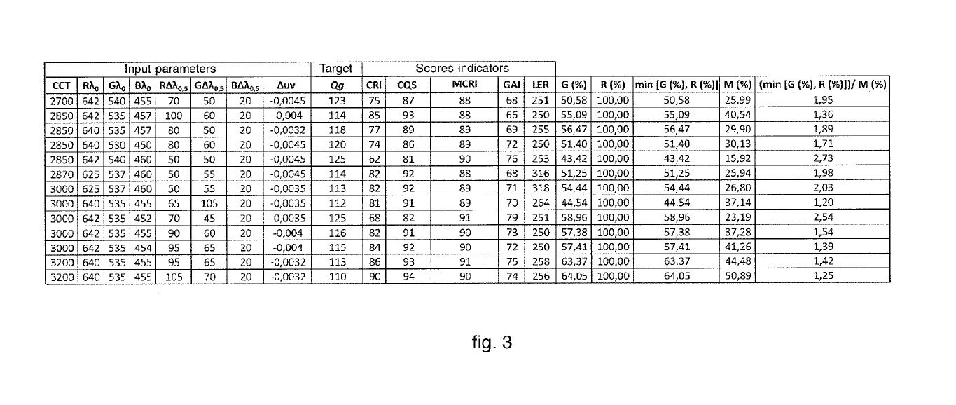

FIGS. 3-5 are used to describe first forms of embodiment of luminous sources according to the present invention, with light emission spectrums with color temperature CCT comprised between 2500K and 3300K.

The table in FIG. 3 shows some examples of light emission spectrums corresponding to this first form of embodiment, identified by the parameters Bλ₀, Gλ₀, Rλ₀, BΔλ_{0.5,} GΔλ_{0.5}, RΔλ_{0.5} and Δuv as defined above.

The table in FIG. 3 also shows the values detected by the indicators Qg, CRI, CQS, MCRI, GAI and LER.

The table in FIG. 3 also shows the data relating to the light intensities normalized for the peak of green G(%) and for the peak of red R(%), as well as the minimum value of normalized light intensity between that of the peak of green and red, that is min [G(%), R(%)].

The value of light intensity of the minimum point M(%) is also shown for the color temperatures CCT comprised between 2500K and 3300K, and the ratio (min [G(%), R(%)])/M(%). In FIG. 3 it can be seen how said ratio has a value always greater than or equal to 1.20.

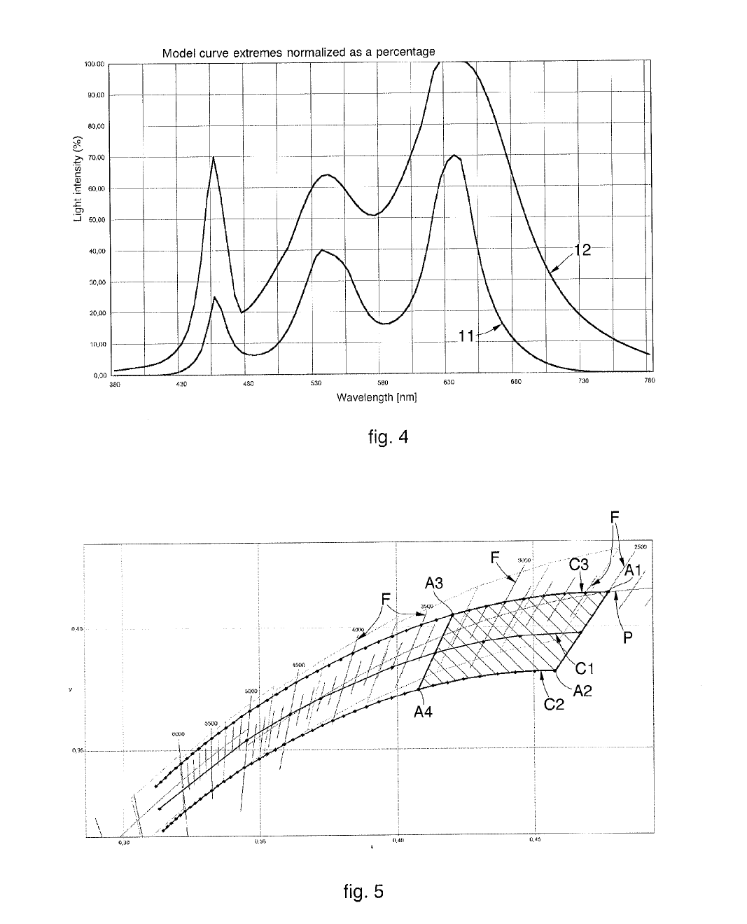

With reference to FIG. 4, the plurality of spectral curves is contained between a first lower emission spectrum 11 and a second upper emission spectrum 12 that respectively delimit the minimum and maximum parameters of the emission spectrums. In other words, the first emission spectrum 11 and the second emission spectrum 12 delimit the area in which one of the curves of the spectrum according to the present invention is contained as far as this first form of embodiment is concerned.

From Table 2, shown below, the minimum and maximum values are deduced relating respectively to the first emission spectrum 11 and the second emission spectrum 12 of FIG. 4.

TABLE 2

| | Min | Max | |
|---|---|---|---|
| CCT | 2500 | 3300 | K |
| Rλ₀ | 610 | 670 | nm |
| Gλ₀ | 500 | 570 | nm |
| Bλ₀ | 420 | 480 | nm |
| RΔλ_{0.5} | 45 | 120 | nm |
| GΔλ_{0.5} | 45 | 105 | nm |
| BAλ_{0.5} | 10 | 30 | nm |
| R (%) | 70 | 100 | Intensity (%) |
| G (%) | 40 | 65 | Intensity (%) |
| B (%) | 25 | 70 | Intensity (%) |
| Δuv | −0.01 | 0.0029 | |

Possible forms of embodiment, for example set forth in Table 2, provide that, for emission spectrums with CCT comprised between 2500K and 3300K, the chromatic distance Auv is comprised between −0.0108 and 0.0029 assuming that the constant K of the formula identified above is comprised between ±0.0054.

In FIG. 5, in the chromaticity space, an area is identified which includes the illumination sources that respect the parameters set forth in Table 2 and the relation between the chromatic coordinates (x, y) set forth above.

In particular, referring to FIG. 5, the area which includes the illumination sources identified by the parameters of Table 2 has four vertexes, respectively A1, A2, A3 and A4, which have the chromatic coordinates:
A1=(0.4770; 0.41368)
A2=(0.45743; 0.38153)
A3=(0.42059; 0.40475)
A4=(0.40788; 0.37424)
   A1 and A2 being chromatic coordinates referred to the color temperature 2500K, while A3 and A4 being chromatic coordinates referred to the color temperature 3300K.

Table 3 identifies a possible implementation of the present invention for emission spectrums comprised in a CCT between 2650K and 3300K. In this form of embodiment it is provided that the constant K of the formula identified above is comprised between ±0.0030.

TABLE 3

| | Min | Max | |
|---|---|---|---|
| CCT | 2650 | 3300 | K |
| Rλ₀ | 620 | 645 | nm |
| Gλ₀ | 520 | 545 | nm |
| Bλ₀ | 440 | 470 | nm |
| RΔλ_{0.5} | 45 | 105 | nm |
| GΔλ_{0.5} | 45 | 105 | nm |
| BΔλ_{0.5} | 10 | 27 | nm |
| R (%) | 70 | 100 | Intensity (%) |
| G (%) | 40 | 65 | Intensity (%) |
| B (%) | 25 | 70 | Intensity (%) |
| Δuv | −0.0078 | 0.0005 | |

In the chromaticity space, the area which includes the sources of illumination identified by the parameters of Table 3 has four vertexes, respectively B1, B2, B3 and B4 (FIG. 2c), which have the chromatic coordinates:
B1=(0.46084; 0.40594)
B2=(0.45069; 0.38812)
B3=(0.41765; 0.39771)
B4=(0.4106; 0.38076)
   B1 and B2 being chromatic coordinates referred to the color temperature 2650K, and B3 and B4 being chromatic coordinates referred to the color temperature 3300K. The chromatic coordinates are determined by setting, in the formula identified above, a value of the constant K comprised between ±0.0030 and −0.0030

Table 4 shows the maximum and minimum obtainable intervals of the indicators with the emission spectrums relating to this form of embodiment.

TABLE 4

| | Min | Max |
|---|---|---|
| CRI | 50 | 90 |
| Qg(CQS 9.0) | 105 | 125 |
| MCRI(3001x) | 88 | 100 |
| GAI | 65 | |
| LER | 250 | |

### Example 2

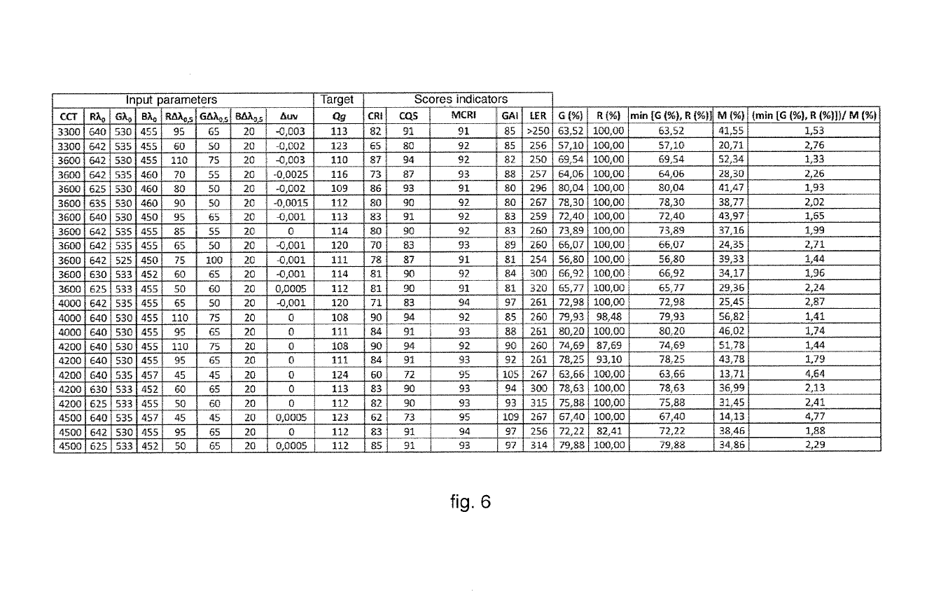

FIGS. 6-8 are used to describe second forms of embodiment of luminous sources in accordance with the present invention, with light emission spectrums with color temperature CCT comprised between 3200K and 4500K.

The table in FIG. 6 shows some examples of light emission spectrums corresponding to this second form of embodiment identified by means of the parameters Bλ₀, Gλ₀, Rλ₀, BΔλ_{0.5}, GΔλ_{0.5}, RΔλ_{0.5} and Δuv, together with the values detected of the indicators Qg, CRI, CQS, MCRI, GAI and LER.

Table 6 also shows the data relating to the light intensities normalized for the peak of green G(%) and for the peak of red R(%), as well as the minimum value of normalized light intensity between the peak of green and red, that is, min [G(%), R(%)].

It also shows the light intensity value of the minimum point M(%) for the color temperatures CCT comprised between 3200K and 4500K, and the ratio (min[G(%), R(%),]/M(%). In FIG. 6 it can be seen how said ratio has a value always greater than or equal to 1.20, and in particular greater than 1.22.

With reference to FIG. 7, the plurality of spectral curves of this form of embodiment is contained between a first lower emission spectrum 111, and a second upper emission spectrum 112 that respectively delimit the minimum and maximum parameters of the emission spectrums. The first emission spectrum 111 and the second emission spectrum 112 delimit the zone which contains one of the curves of the spectrums according to the present invention with regard to this second form of embodiment.

From Table 5, shown below, the minimum and maximum values are deduced corresponding respectively to the first emission spectrum 111 and to the second emission spectrum 112 in FIG. 7.

TABLE 5

| | Min | Max | |
|---|---|---|---|
| CCT | 3200 | 4500 | K |
| Rλ₀ | 610 | 670 | nm |
| Gλ₀ | 500 | 570 | nm |
| Bλ₀ | 420 | 480 | nm |
| RΔλ_{0.5} | 45 | 120 | nm |
| GΔλ_{0.5} | 45 | 105 | nm |
| BΔλ_{0.5} | 10 | 30 | nm |
| R (%) | 80 | 100 | Intensity (%) |
| G (%) | 52 | 82 | Intensity (%) |
| B (%) | 35 | 100 | Intensity (%) |
| Δuv | −0.01 | 0.0058 | |

Possible forms of embodiment, for example set forth in Table 5, provide that, for emission spectrums with CCT comprised between 3200K and 4500K, the chromatic distance Δuv is comprised between −0.0082 and 0.0058, assuming that the constant K of the formula identified above is comprised between ±0.0054.

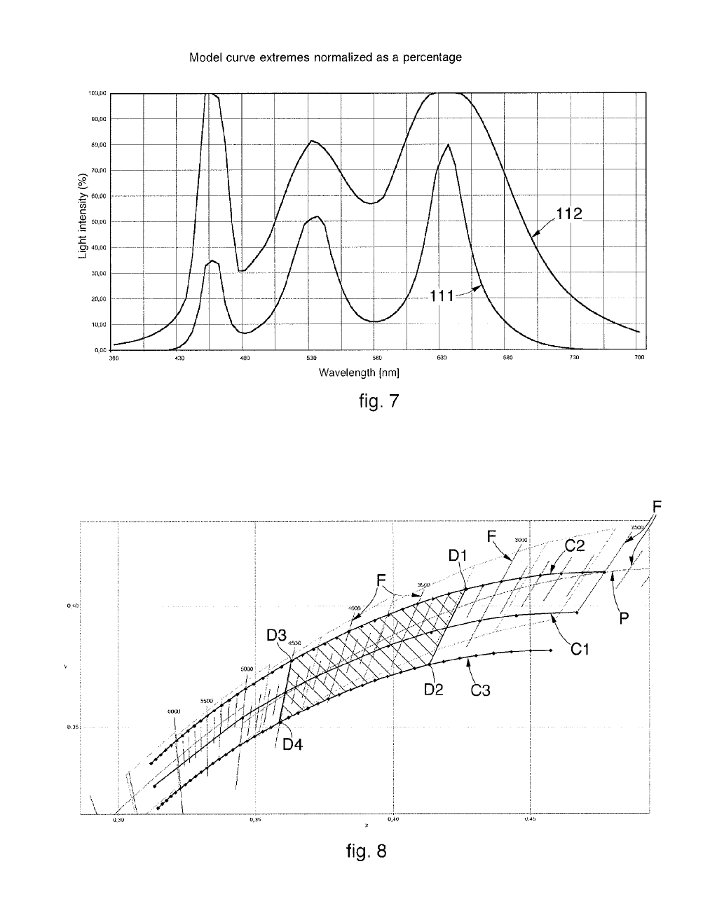

FIG. 8 identifies, in the chromaticity space, a zone which includes the illumination sources that respect the parameters set forth in Table 5 and the relation between the chromatic coordinates (x, y) set forth above.

In particular, referring to FIG. 8, the zone which includes the illumination sources identified by the parameters of Table 5 has four vertexes, respectively D1, D2, D3 and D4, which have the chromatic coordinates:
D1=(0.42675; 0.40667)
D2=(0.41321; 0.3758)
D3=(0.36325; 0.37745)
D4=(0.35876; 0.35208)

D1 and D2 being chromatic coordinates referred to the color temperature 3200K, D3 and D4 being chromatic coordinates referred to the color temperature 4500K.

In Table 6 a possible implementation of the present invention is identified for emission spectrums comprised in a CCT between 3300K and 4500K. In this form of embodiment it is provided that the constant K of the formula identified above is comprised between ±0.0030.

TABLE 6

| | Min | Max | |
|---|---|---|---|
| CCT | 3300 | 4500 | K |
| Rλ₀ | 620 | 650 | nm |
| Gλ₀ | 520 | 550 | nm |
| Bλ₀ | 445 | 470 | nm |
| RΔλ_{0.5} | 45 | 120 | nm |
| GΔλ_{0.5} | 45 | 100 | nm |
| BΔλ_{0.5} | 10 | 27 | nm |
| R (%) | 80 | 100 | Intensity (%) |
| G (%) | 52 | 82 | Intensity (%) |
| B (%) | 35 | 100 | Intensity (%) |
| Δuv | −0.0055 | 0.0034 | |

In the chromaticity space, the area which includes the illumination sources identified by the parameters of Table 6 has four vertexes, respectively E1, E2, E3 and E4, (FIG. 2c) which have the chromatic coordinates:
E1=(0.41765; 0.39771)
E2=(0.4106; 0.38076)
E3=(0.3622; 0.37153)
E4=(0.35971; 0.35743)
   E1 and E2 being chromatic coordinates referred to the color temperature 3200K, E3 and E4 being chromatic coordinates referred to the color temperature 4500K. Said chromatic coordinates are determined by setting, in the formula identified above, a value of the constant K comprised between +0.0030 and −0.0030.

Table 7 shows the maximum and minimum intervals obtainable of the indicators with the emission spectrums relating to this form of embodiment.

TABLE 7

| | Min | Max |
|---|---|---|
| CRI | 50 | 90 |
| Qg(CQS 9.0) | 107 | 125 |
| MCRI(3001x) | 90 | 100 |
| GAI | 78 | |
| LER | 250 | |

### Example 3

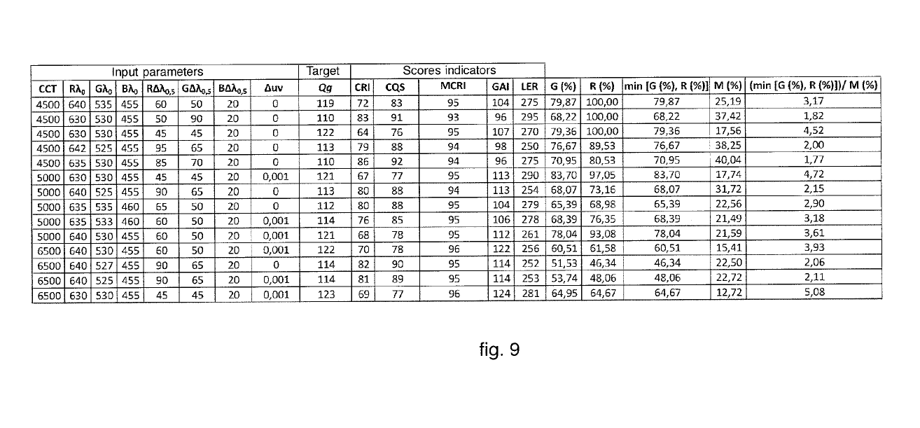

FIGS. 9-11 are used to describe third forms of embodiment of luminous sources according to the present invention, with light emission spectrums with color temperature CCT comprised between 4200K and 6500K.

The table in FIG. 9 shows some examples of light emission spectrums corresponding to this third form of embodiment, identified by means of the parameters Bλ₀, Gλ₀, Rλ₀, BΔλ_{0.5}, GΔλ_{0.5}, RΔλ_{0.5} and Δuv, together with the values detected of the indicators CRI, CQS, MCRI, GAI and LER.

The table in FIG. 9 also shows the data relating to the light intensities normalized for the peak of green G(%) and for the peak of red R(%), as well as the minimum value of normalized light intensity between that of the peak of green and red, that is min [G(%), R(%)].

It also shows the light intensity value of the minimum point M(%) for the color temperatures CCT comprised between 4200K and 6500K, and the ratio (min[G(%), R(%),]/M(%). In FIG. 9 it can be seen how said ratio has a value always greater than or equal to 1.20, and in particular greater than 1.40.

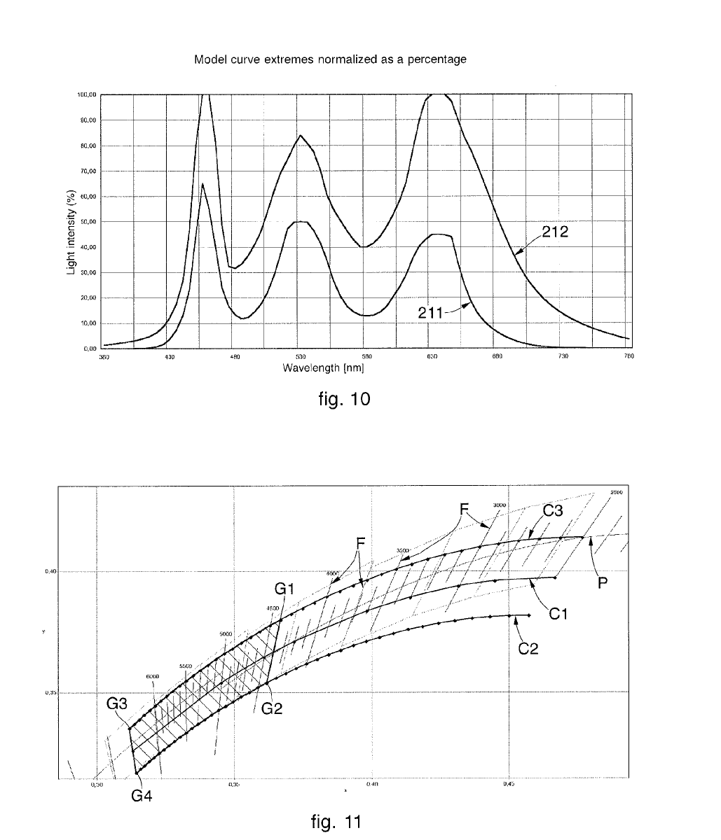

With reference to FIG. 10, the plurality of spectral curves of this form of embodiment is contained between a first lower emission spectrum 211, and a second upper emission spectrum 212 that respectively delimit the minimum and maximum parameters of the emission spectrums. The first emission spectrum 211 and the second emission spectrum 212 delimit the area which contains one of the curves of the spectrums according to the present invention with regard to this third form of embodiment.

From Table 8, shown below, minimum and maximum values are deduced relating respectively to the first emission spectrum 211 and to the second emission spectrum 212 in FIG. 10.

TABLE 8

| | Min | Max | |
|---|---|---|---|
| CCT | 4200 | 6500 | K |
| Rλ₀ | 610 | 670 | nm |
| Gλ₀ | 500 | 570 | nm |
| Bλ₀ | 420 | 480 | nm |
| RΔλ_{0.5} | 45 | 120 | nm |
| GΔλ_{0.5} | 45 | 95 | nm |
| BΔλ_{0.5} | 10 | 30 | nm |
| R (%) | 45 | 100 | Intensity (%) |
| G (%) | 50 | 85 | Intensity (%) |
| B (%) | 65 | 100 | Intensity (%) |
| Δuv | −0.01 | 0.0067 | |

Possible forms of embodiment, for example set forth in Table 8, provide that, for emission spectrums with CCT comprised between 4200K and 6500K, the chromatic distance Δuv is comprised between −0.0056 and 0.0067, assuming that the constant K of the formula identified above is comprised between ±0.0054.

FIG. 11 identifies, in the chromaticity space, an area which includes the illumination sources that respect the parameters set forth in Table 8 and the relation between the chromatic coordinates (x, y) set forth above.

In particular, referring to FIG. 11, the area which includes the illumination sources identified by the parameters of Table 8 has four vertexes, respectively G1, G2, G3 and G4, which have the chromatic coordinates:
G1=(0.3751; 0.3845)
G2=(0.3689; 0.3578)
G3=(0.3119; 0.3351)
G4=(0.3145; 0.3168)

G1 and G2 being chromatic coordinates referred to the color temperature 4200K, while G3 and G4 being chromatic coordinates referred to the color temperature 6500K.

In Table 9 a possible implementation of the present invention is identified for emission spectrums comprised in a CCT between 4500K and 6500K. In this form of embodiment it is provided that the constant K of the formula identified above is comprised between ±0.0030.

TABLE 9

| | Min | Max | |
|---|---|---|---|
| CCT | 4500 | 6500 | K |
| Rλ₀ | 620 | 650 | nm |
| Gλ₀ | 520 | 550 | nm |
| Bλ₀ | 445 | 470 | nm |
| RΔλ_{0.5} | 45 | 100 | nm |
| GΔλ_{0.5} | 45 | 95 | nm |
| BΔλ_{0.5} | 10 | 27 | nm |
| R (%) | 45 | 100 | Intensity (%) |
| G (%) | 50 | 85 | Intensity (%) |
| B (%) | 65 | 100 | Intensity (%) |
| Δuv | 0 | 0.0042 | |

In the chromaticity space, the area which includes the illumination sources identified by the parameters in Table 9 has four vertexes, respectively H1, H2, H3 and H4 (FIG. 2c), which have the chromatic coordinates:
H1=(0.3622; 0.37153)
H2=(0.35971; 0.35743)
H3=(0.31251; 0.33093)
H4=(0.31392; 0.32078)
   H1 and H2 being chromatic coordinates referred to the color temperature 4500K, and G3 and G4 being chromatic coordinates referred to the color temperature 6500K. Said chromatic coordinates are determined by setting, in the formula identified above, a value of the constant K comprised between +0.0030 and −0.0030.

Table 10 shows the maximum and minimum intervals obtainable of the indicators with the emission spectrums relating to this form of embodiment.

TABLE 10

| | Min | Max |
|---|---|---|
| CRI | 50 | 90 |
| Qg(CQS 9.0) | 110 | 125 |
| MCRI(3001x) | 92 | 100 |
| GAI | 85 | |
| LER | 250 | |

Results Obtained

Analyzing the data of the indicators CRI, CQS, MCRI, GAI and LER shown in the tables in FIGS. 3, 6 and 9, it can be seen that the emission spectrums identified by the Applicant give low scores, rather distant from 100, for CRI, but high scores for CQS, MCRI and GAI.

Forms of embodiment of the present invention provide that the emission spectrums have a parameter of CRI≧50, preferably CRI≧60, but in any case no higher than CRI=90.

These values of the indicators show that spectral curves of light emission are obtained with a light neither too warm nor too cold.

Indeed, high values of the MCRI index confirm that a luminous source is obtained with a high degree of pleasantness.

The indicator LER shows values within the average of current luminous sources available on the market.

It is also possible to see how the emission spectrums in accordance with the present invention have a saturation value QG less than 125, which allows to obtain a good compromise of color enhancement.

It is clear that modifications and/or additions of parts may be made to the luminous source with pleasing light as described heretofore, without departing from the field and scope of the present invention.

For example it is possible to provide that, in other forms of embodiment, the curve of the emission spectrum has four peaks that correspond respectively to the emission of a blue, green, yellow and red luminous source, the peak of yellow being interposed between the peak of the green and the red.

It is also clear that, although the present invention has been described with reference to some specific examples, a person of skill in the art shall certainly be able to achieve many other equivalent forms of luminous source with pleasing light, having the characteristics as set forth in the claims and hence all coming within the field of protection defined thereby.

1. Luminous source with pleasing light having a light emission spectrum with color temperatures comprised between 2500K and 6500K and provided with three peaks of light emission (R, G, B) situated in correspondence to the red, green and blue colors, said emission spectrum having chromatic coordinates (x, y) of the white point in the chromaticity space comprised in the area defined by the formula y=−6.079·10⁻¹⁰·x²+7.1496·10⁻⁶·x−0.0195+K, in which K is a constant number variable between −0.0054 and +0.0054, characterized in that:
the peak of the red (R) is comprised between 610 nm and 670 nm and has a spectral amplitude (RΔλ_{0.5}) comprised between 45 nm and 120 nm;
the peak of the green (G) is comprised between 500 nm and 570 nm and has a spectral amplitude (GΔλ_{0.5}) comprised between 45 nm and 105 nm;
the peak of the blue (B) is comprised between 420 nm and 480 nm and has a spectral amplitude (BΔλ_{0.5}) comprised between 10 nm and 30 nm,
in that said emission spectrum, between said peak of the red (R) and said peak of the green (G), has a minimum point (M), and in that the minimum value of light intensity chosen between that of the peak of the green (G) and that of the peak of the red (R) in proportion to the value of light intensity of the minimum point (M) is greater than or equal to 1.20.

2. Luminous source as in claim 1, characterized in that the minimum value of light intensity chosen between that of the peak of the green (G) and that of the peak of the red (R) in proportion to the value of light intensity of the minimum point (M) is less than 10.

3. Luminous source as in claim 1 or 2, characterized in that said constant number K is comprised between −0.0030 and +0.0030.

4. Luminous source as in any claim hereinbefore, characterized in that said emission spectrum has a color temperature comprised between 2500K and 3300K, and in that the peak of the red has an intensity comprised between 70% and 100%, the peak of the green has an intensity comprised between 40% and 65%, the peak of the blue has an intensity comprised between 25% and 70%.

5. Luminous source as in claim 4, characterized in that said emission spectrum has a chromatic distance (Δuv) comprised between −0.0108 and 0.0029.

6. Luminous source as in any claim hereinbefore, characterized in that said emission spectrum has a color temperature comprised between 2650K and 3300K, and in that the peak of the red (R) is comprised between 620 nm and 645 nm and has a spectral amplitude (RΔλ_{0.5}) comprised between 45 nm and 105 nm; the peak of the green (G) is comprised between 520 nm and 545 nm, and has a spectral amplitude (GΔλ_{0.5}) comprised between 45 nm and 105 nm; the peak of the blue (B) is comprised between 440 nm and 470 nm, and has a spectral amplitude (BΔλ_{0.5}) comprised between 10 nm and 30 nm.

7. Luminous source as in claim 6, characterized in that said emission spectrum has a chromatic distance (Δuv) comprised between −0.0078 and 0.0005.

8. Luminous source as in claim 1, 2 or 3, characterized in that said emission spectrum has a color temperature comprised between 3200K and 4500K, and in that the peak of the red has an intensity comprised between 80% and 100%, the peak of the green has an intensity comprised between 52% and 82%, the peak of the blue has an intensity comprised between 35% and 100%.

9. Luminous source as in claim 8, characterized in that said emission spectrum has a chromatic distance (Δuv) comprised between −0.0082 and 0.0058.

10. Luminous source as in any of the claim 1, 2, 3, 8 or 9, characterized in that said emission spectrum has a color temperature comprised between 3300K and 4500K, and in that the peak of the red (R) is comprised between 620 nm and 650 nm, and has a spectral amplitude (RΔλ_{0.5}) comprised between 45 nm and 120 nm; the peak of the green (G) is comprised between 520 nm and 550 nm, and has a spectral amplitude (GΔλ_{0.5}) comprised between 45 nm and 100 nm; the peak of the blue (B) is comprised between 445 nm and 470 nm, and has a spectral amplitude (BΔλ_{0.5}) comprised between 10 nm and 30 nm.

11. Luminous source as in claim 10, characterized in that said emission spectrum has a chromatic distance (Δuv) comprised between −0.0055 and 0.0034.

12. Luminous source as in claim 1, 2 or 3, characterized in that said emission spectrum has a color temperature comprised between 4200K and 6500K, and in that the peak of the red has an intensity comprised between 45% and 100%, the peak of the green has an intensity comprised between 50% and 85%, the peak of the blue has an intensity comprised between 65% and 100%.

13. Luminous source as in claim 12, characterized in that said emission spectrum has a chromatic distance (Δuv) comprised between −0.0056 and 0.0067.

14. Luminous source as in any of the claim 1, 2, 3, 12 or 13, characterized in that said emission spectrum has a color temperature comprised between 4500K and 6500K, and in that the peak of the red (R) is comprised between 620 nm and 650 nm, and has a spectral amplitude (RΔλ_{0.5}) comprised between 45 nm and 100 nm; the peak of the green (G) is comprised between 520 nm and 550 nm, and has a spectral amplitude (GΔλ_{0.5}) comprised between 45 nm and 95 nm; the peak of the blue (B) is comprised between 445 nm and 470 nm, and has a spectral amplitude (BΔλ_{0.5}) comprised between 10 nm and 30 nm.

15. Luminous source as in claim 14, characterized in that said emission spectrum has a chromatic distance (Δuv) comprised between −0.0027 and 0.0042.

16. Luminous source as in any claim hereinbefore, characterized in that said peak of the blue (B) has a spectral amplitude less than 30 nm, preferably comprised between 10 nm and 27 nm.
